(19) United States
(12) Patent Application Publication
(10) Pub. No.: US 2002/0054152 A1
(43) Pub. Date: May 9, 2002

(54) Menu infrastructure apparatus and method

(76) Inventors: Murugan Palaniappan, Saratoga, CA (US); Yvonne Wai-Yee Chan, Belmont, CA (US); Suraj Gaurav, Belmont, CA (US)

Correspondence Address: Jeffrey D. Wheeler, McAndrews, Held & Malloy, Ltd., Suite 3400, 500 W. Madison St., Chicago, IL, 60661, US

(21) Appl. No.: 09/893,134

(22) Filed: Jun. 27, 2001

Related U.S. Application Data
(60) Provisional application No. 60/164,021, filed on Aug. 23, 1999.

(51) Int. Cl. G09G 5/00

(52) U.S. Cl. 345/810

(57) ABSTRACT

A menu infrastructure component, or menu application, which runs as a layer on top of a platform, wherein the platform is used to run various applications. The menu application can service, with menu generating capabilities, any of the applications running on the platform. Based upon the identity (or locale) of the user, a particular set of images will be created to provide the preferred language (for instance) for display in the menus. During runtime, these criteria are used to pick out a version of menus (e.g., Japanese menus or English menus) and thereafter render them for display. Each of the applications can have inter-application links, which jump from one application to another. The applications can also have intra-application links, which jump to different capabilities or functions within the particular application. The Menu Application serves to manage and render the inter- and intra-application hyperlinks for an entire web site.

### RELATED APPLICATIONS

This application is related to the following—U.S. Provisional patent application having Ser. No. 60/164,021, entitled “Method and Apparatus to Provide Custom Configurable Business Applications from a Standardized Set of Components,” filed Aug. 23, 1999; Utility patent application having Ser. No. 09/440,326, entitled “Method for Providing Custom Configurable Business Applications from a Standardized Set of Components,” filed Nov. 15, 1999; Utility patent application having Ser. No. 09/439,764, entitled “Apparatus to Provide Custom Configurable Business Applications from a Standardized Set of Components,” filed Nov. 15, 1999; Utility patent application having Ser. No. 09/658,415, entitled “Method for Developing Custom Configurable Business Applications,” filed Sep. 8, 2000; Utility patent application having Ser. No. 09/658,416, entitled “Integrated Design Environment for a Commerce Server System,” filed Sep. 8, 2000; Utility patent application having Ser. No. 09/697,271, entitled “Method for Providing Template Applications for Use by a Plurality of Modules,” filed Oct. 25, 2000; Utility patent application having Ser. No. 09/691,461, entitled “Method and Apparatus for Providing News Client and Server Architecture and Protocols,” filed Oct. 17, 2000; Utility patent application having Ser. No. 09/684,491, entitled “Adapter and Connector Framework for Commerce Server System,” filed Oct. 4, 2000; Utility patent application having Ser. No. 09/702,148, entitled “E-Commerce Application Built Using Workflows on a Workflow Engine and Methods Thereof,” filed Oct. 30, 2000; Utility patent application having Ser. No. 09/702,290, entitled “Presentation Layer for Business Application Development and Methods Thereof,” filed Oct. 30, 2000; Utility patent application having Ser. No. 09/702,291, entitled “Scalability, Availability, and Management Features for Business Commerce Server,” filed Oct. 30, 2000; Utility patent application having Ser. No. 09/706,304, entitled “Content Management Framework for Business Commerce Server,” filed Nov. 3, 2000; Utility patent application having Ser. No. 09/727,912, entitled “Workflow Driven Rules-based Generation of Personalizable Web Pages,” filed Nov. 28, 2000; Utility patent application having Ser. No. 09/658,416, entitled “Integrated Design Environment for a Commerce Server System,” filed Sep. 8, 2000; and Provisional patent application having Ser. No. 60/243,580, entitled “Globalization Services for Business Commerce Server”—each of which is hereby incorporated by reference in their entirety.

### FIELD OF THE INVENTION

The present invention relates to an apparatus and method for generation of menu items pertaining to applications running on a server platform. A separate menu generating layer is used to generate various menu configurations, thereby freeing the developer from incorporating the menu specific information in the applications.

### BACKGROUND OF THE INVENTION

Asera System.

The prior referenced applications provide for methods and apparatuses for creating custom configurable business or channel applications from a standardized set of components. More specifically, the referenced invention(s) allow each business to select from a set of applications, customize that set of applications, and/or develop new customized applications from a set of development components. The prior applications provide for a server based method wherein best-of-breed services and/or applications are integrated in a seamless fashion and offered to enterprise businesses which develop customized business service applications through using the system. The server device is previously (and hereafter) referred to as the Asera Commerce Server (ACS).

The ACS includes a Commerce Server that provides a core set of technology (or application) services. A unique architecture and framework are provided by the Commerce Server, which facilitates development and use of customized applications. Most interactions with external systems or users are managed as Business Objects. The service application code is maintained separate from the data. This enables the system to quickly include (and/or change) new business processes or technology components without having to write substantial amounts of new code. The business result is more rapid customer deployments and/or modifications that are customized to include (if desired) the proprietary or competitive business practices of a contracting company.

The ACS can be viewed as a form of ASP (Application Service Provider). An ASP is generally an outsourcing business model. The ASP business model requires an open and extendable architecture that allows a system to implement a customer-specific business solution in a short period of time. The ACS takes best-of-breed applications and incorporates them into one integrated solution to provide the ASPs. The architecture is scalable and extensible. A customized business (or channel) application solution is built for each enterprise company. The solution uses a “modular” or step-wise or “plug-and-play” approach towards building new applications. An enterprise company can then quickly acquire a turn-key e-commerce solution to automate their channel relationships. The system presents little (or no) risk for the enterprise company because a solution is built by the present system. The costs of undertaking such a development exist as a fixed development cost of the system. Any resulting customized solutions are implemented in considerably less time than previous systems. The enterprise company might pay for the application services on a cost per transaction or a fixed fee basis.

The ACS is used to capture the particularized (or specific) business processes for a given customer, and these business processes are converted into a set of customized applications. The ACS uses business steps and rules to construct the application. The objects are data representations. The steps are business operations with a defined set of input and output ports, with each port also having a defined set of parameters. The business rules are used to capture customer specific business practices. A unique tool that employs a graphical user interface (GUI) allows a developer to arrange various steps (or composite steps) into business processes or workflows. The tool provides library catalogs of steps to be applied to the various objects. The connections between steps are also verified as correct. A graphical display of the business process is shown, and rules can thereafter be applied to provide further customization by conditionally tagging certain points. Hence, to create a business process (or application) for any given business, tools are provided which allow modules (or steps) to be plugged or dropped into the potential process. The steps can be moved or the connections modified. An initial person-to-person (or other type of) interview with the business (or customer) can be used to produce the framework for arranging the steps according to the needs of that particular business (i.e., customized routines). The modular aspect of the present system allows this to be done—and modifications made—in a relatively quick fashion. For instance, if a process has been created, but the customer wants it to behave in two different manners, then certain rules can be applied to provide the desired results, depending on conditional triggers that can be associated with the underlying Business Objects.

Application Menu Development and Display

By definition, a menu system is the mechanism for displaying a list of operations which a user can thereafter select to perform in association with an application or the like. For instance, many operating systems, or windowing systems, provide static or pop-up menus for showing the list of applications that can be invoked by a user. Traditional client-server applications provide key- or mouse-driven menus for users to choose the desired application function to be executed. The menu choices might vary, based upon the user's privileges and preferences. Tools have been provided for defining and modifying the menu structure. The rendering of the menus is usually handled and determined by the operating system or the applications associated with the menus.

In a web environment, hyperlinks are generally available on the pages for the user to navigate throughout the web site. As a result, these hyperlinks serve similar functions as the menu system, except that the hyperlinks can occur at any location within the web page. For instance, the hyperlinks might be grouped in certain areas (top, bottom, left, or right), or the hyperlinks might even be scattered throughout the document contents. There is generally no systematic approach in defining these menus. Instead, the menus are produced using ad-hoc approaches to define static links on the pages. Programmatic approaches might also be used, with the results still being scattered. In general, it proves to be very problematic to maintain these links based upon the additions, modifications and deletions of a set of web applications or pages within each web site. This is particularly true when the links and/or menus are coded into the application by the developer.

Past systems include platforms where facilities are provided for building applications, but the menu links are coded or developed inside of the applications. Each application so developed needs to provide for links, both internal and external to the application. Generally, it is difficult to provide for a consistent look and feel between the many different applications (developed by different developers). The act of changing any link requires that the actual coding of the application be altered.

Accordingly, what is needed in the field is a standalone component or application that can be used to generate menus or hyperlinks and be available to run across many different applications running on a platform. This standalone component will alleviate the need for menu-producing code to be developed inside of the various applications.

### SUMMARY OF THE INVENTION

The present invention provides a menu infrastructure component, also referred to as a Menu Application, which runs as a layer on top of a platform wherein the platform is used to run various applications. As a result, the Menu Application runs across, or can service with menu generating capabilities, any of the applications running on the platform.

Each of the applications might have inter-application links, which jump from one application to another. The applications will also likely have intra-application links which jump to different capabilities or functions within the particular application. The Menu Application serves to manage and render the inter- and intra-application hyperlinks for each web site. This Menu Application is described in the present context as being built as a functional layer on top of the Asera Platform. However, the Menu Application—and the principles surrounding its operation and implementation—are meant to be equally applicable to any other type of platform which would benefit from a separate component for rendering menu (or linking) information. As presently applied, the Menu Application handles the rendering of the menu links on all the Asera-based applications pages. The application can also handle menu links that lead to external (non-Asera) applications.

Certain features of the Menu Application, as further detailed below, include (but are not limited to): (1) Authorization/Authentication—displays only menu links which the user is authorized to execute. This feature prompts for a login if authentication is required. (2) State Management—determines and tracks the menu state and renders the corresponding menu item as “active” to match the active application page. (3) Globalization—displays the appropriate versions of the images/text and menu links based on the user locale. (4) Personalization supports multiple versions of menu hierarchy chosen by the vendor identification (ID). The feature also allows individual users to create bookmarks of frequently used menu items for quick access. (5) Centralization—enables query or generation of sitemap easily since all application menu information is stored in a centralized repository—the menu configuration file—rather than scattered within the application code. The encapsulation can highly increase the productivity for both application developers and administrators. (6) Configurable—both the menu hierarchy and rendering styles are easily configurable through the graphical user interface.

As a result, certain benefits of this design include: (1) Faster time-to-implement—when developing a new application, no programming is required to manage or render menu items. The developer needs to add only the application entry points as menu items in the configuration file. (2) Faster time-to-maintenance—when restructuring the web site (such as adding or removing applications), the menu links can be restructured easily by modifying the entries in the centralized configuration file. It is unnecessary to make changes in the application pages to include or exclude certain links.

According to one aspect of the present invention, a menu generating apparatus is provided for rendering and displaying menu items associated with applications running on a computing platform, the menu generating apparatus comprising: a platform for running a plurality of applications; a menu application associated with the plurality of applications running on the platform; and a menu hierarchy file that is accessible by the menu application, wherein menu items pertaining to the plurality of applications are registered and stored in the menu hierarchy file, whereby the menu application layer utilizes the stored menu hierarchy for rendering the menu selections.

According to another aspect of the present invention, a method for rendering and displaying menu items associated with applications running on a computing platform, the method comprising the steps of: developing an application having links to be displayed in association with the application; exposing the links within the application; registering the links in a menu hierarchy file that is stored in association with the computing platform; retrieving the menu hierarchy file from the storage area; using the menu hierarchy file to render the links in designated areas of a display.

The above and other features, aspects and advantages of the present invention will become apparent from the following descriptions and attached drawings.

### BRIEF DESCRIPTION OF THE DRAWINGS

Certain aspects and advantages of the present invention will be apparent upon reference to the accompanying description when taken in conjunction with the following drawings, which are exemplary, wherein:

FIG. 1 is a representative document type definition (DTD), according to one aspect of the present invention.

FIGS. 2A-2D are representative block diagrams, according to one aspect of the present invention, showing menu structures.

FIG. 3 is a representative block diagram, according to one aspect of the present invention, showing the Menu Application in relation to the underlying platform.

FIG. 4 is a representative screen display, according to one aspect of the present invention, showing a Dynamic Trade application Bid/Quote and the selected function thereunder named Create RFQ.

FIG. 5 is a representative screen display, according to one aspect of the present invention, showing an Administration application Community and the selected function thereunder named News Administration.

FIG. 6 is a representative site hierarchy, in light of the examples used, according to one aspect of the present invention.

FIG. 7 is a representative excerpt of the Menu Hierarchy file of Appendix A, according to one aspect of the present invention.

FIG. 8 is a representative excerpt of the Menu Hierarchy file of Appendix A, with certain sections expanded, according to one aspect of the present invention.

FIG. 9 is a representative flow chart showing steps of exposing and registering links in the hierarchy file, according to one aspect of the present invention.

Appendix A is a representative example of Menu Hierarchy file in XML code.

### DESCRIPTION OF THE PREFERRED EMBODIMENTS

For discussion purposes in describing the present invention, representative ACS application examples are used. In ACS applications, Hypertech Markup Language (HTML) pages are developed and rendered using the Presentation Engine constructs such as Master Templates, Wire Frames, and Display Filters. These development time constructs are transformed into Java Server Pages (JSPs) during application compilation time. The actual HTML pages are dynamically generated by executing the respective JSP files at runtime.

The present invention provides an apparatus and method for the stand-alone generation (or rendering) of menu-type information pertaining to applications running on a platform or system. A standalone infrastructure component—referred to as the Menu Application—exists as a layer or module built on top of the platform and provides for centralized organization and rendering of the menu information. The menu rendering process is thereby separated from the development and coding process. Applications can be readily changed without affecting the menu layout. Conversely, menus can be rearranged or modified without affecting the underlying development of the application.

Most client/server systems have a form of built-in menu structure, for instance Windows NT and the like. Web applications, however, are based upon hyperlinks that need to jump from one action to another, and even from one application to another application. Navigation throughout a web site can prove very cumbersome and confusing. The Menu Application (or Menu Infrastructure) of the present invention provides menu structures that can be used to jump from one application to another. The menu structures also provide functions that can be performed within an application, and even instructions on how to perform them.

To provide this functionality, the Menu Application separates certain data from the display setup in order to support flexible rendering styles. This data represents the menu hierarchy, and is stored in an XML-based configuration file. A representative example is provided in Appendix A, and described in more detail below. The menu hierarchy is a tree-structure of menu items, wherein each menu item represents a menu link. For example, a representative top level might correspond to a set of application suites (e.g., Community, Commerce, etc.). A representative second level might correspond to the set of applications that comprises a given suite (e.g., Catalog and Auction in Commerce). A representative third level corresponds to the set of functions available for a given application (e.g., Browse Catalog and Search Catalog, in the Catalog Application). Each menu link is represented by a set of attributes describing the name, caption, images, and so forth.

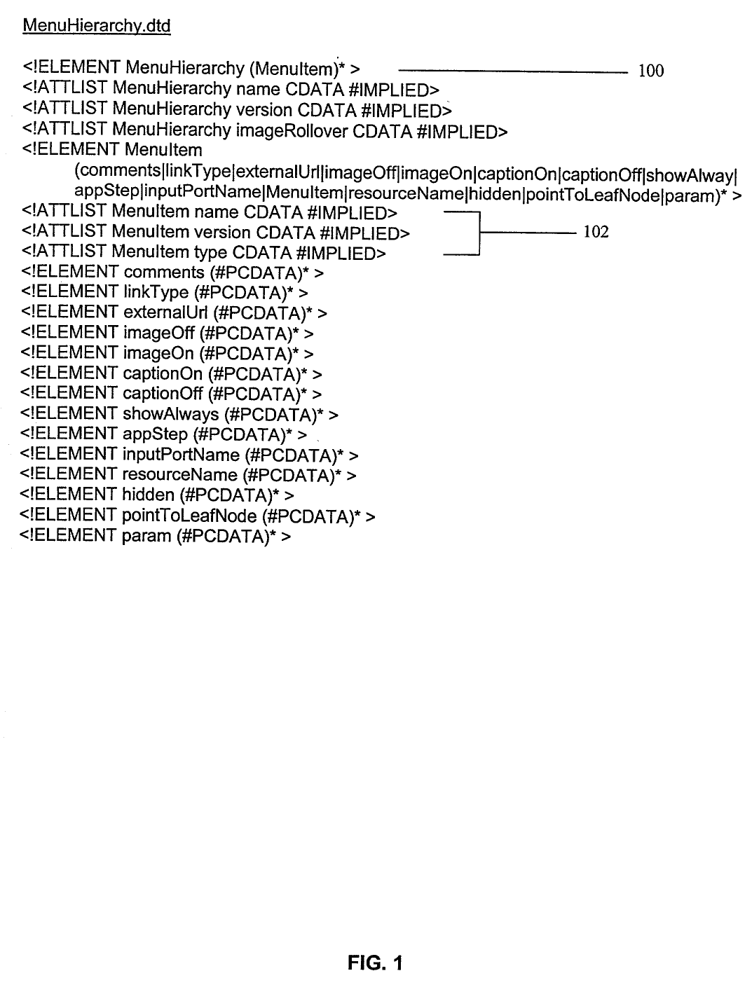

The set of attributes might be provided in any of a variety of ways. The preferred embodiment utilizes a document-type definition (DTD), wherein an example is provided in FIG. 1. A document type definition (DTD) is a particularized definition that follows the rules of a Standard Generalized Markup Language (SGML). A DTD is a specification that usually accompanies a document and identifies the codes (or markup symbols) that are used to separate paragraphs, identify topic headings, and so forth. The DTD identifies how each code or markup is to be processed. Hence, by mailing (or sending) a DTD with a document, any location that has a DTD “reader” (or “SGML compiler”) will be able to process the document and display or print the document as intended by the developer. Accordingly, by using a DTD, a single standard SGML compiler can be used to serve many different kinds of documents that use a range of markup codes and related meanings. The compiler looks at the DTD and then uses this information to print or display the document accordingly. The MenuHierarchy attributes 100 (i.e., name, version, image Rollover, etc.), along with MenuItem attributes 102 (i.e., name, version, type, etc.)

The display setup can be chosen at startup as part of the application parameters. The module is extendible to support additional or custom rendering styles, such as Image Map. At the very least, basic support could include each menu item being rendered as text or an image link, with JavaScript support for rollover action (e.g., font changes, swapping border style from in to out, popup menus, and so forth), and “bubble-type” hints.

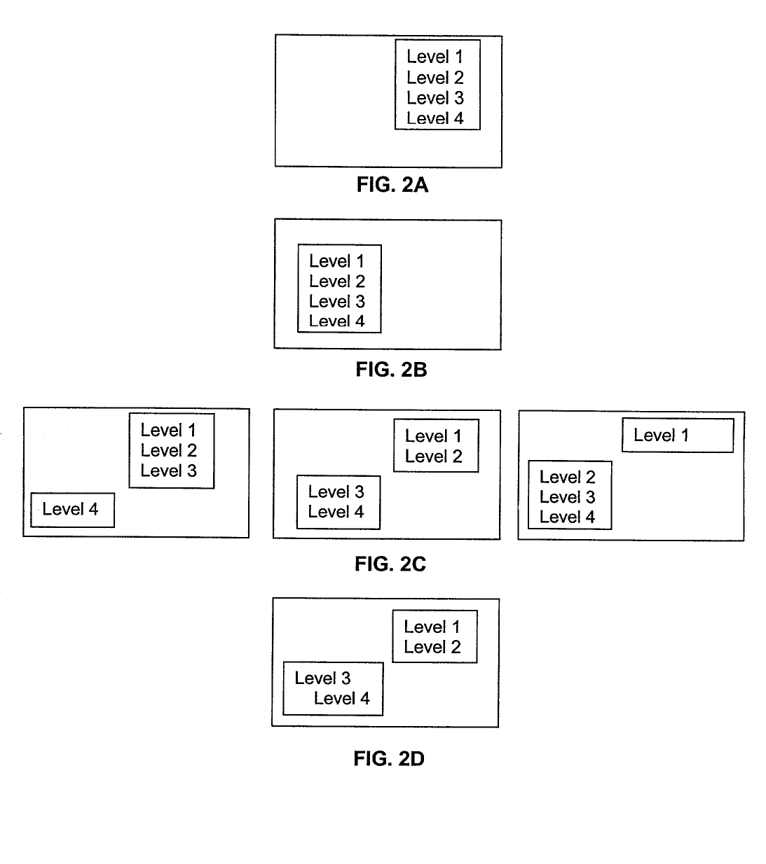

FIGS. 2A-2D next shows different representative layout styles that might be used for the menu items. In FIG. 2A, all the menus are horizontal. In FIG. 2B, all of the menus are vertical. In FIG. 2C, combinations are shown of horizontal and vertical menus. In FIG. 2D, the vertical menu is shown as being able to display sublevels in a cascading format as well. These styles are stored and readily available for the Menu Application to use in presenting the various menu information.

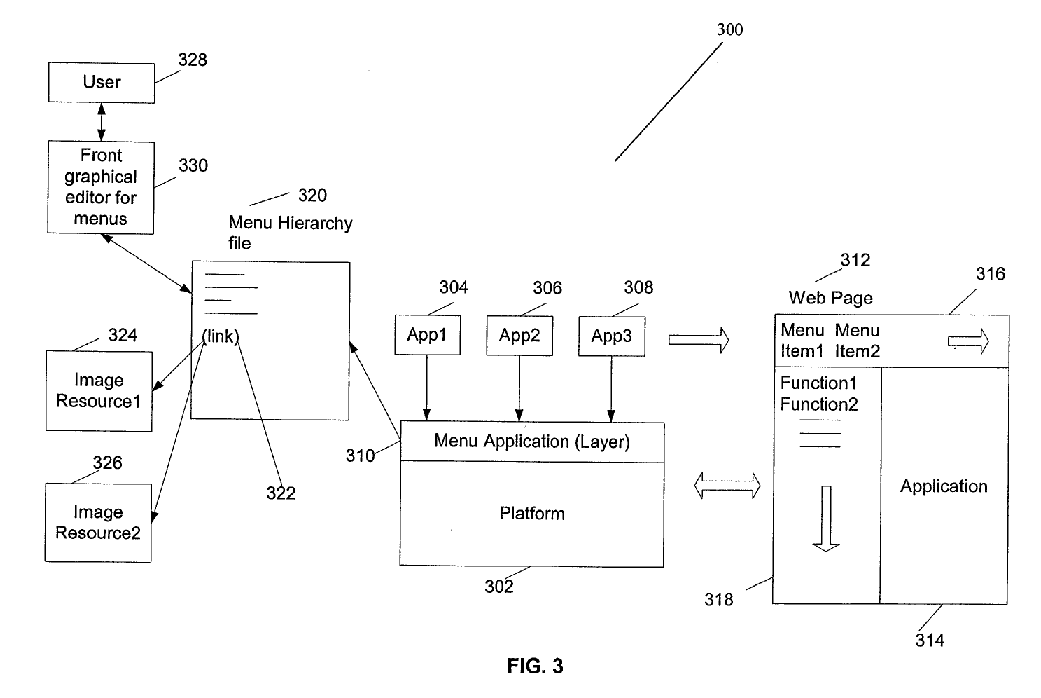

FIG. 3 next shows a representative block diagram of the overall system 300 with the Menu Application shown in relation to other aspects of the system. The platform 302 might represent the Asera Platform, or other comparable platforms for running applications. A plurality of applications will run on the platform 302, the applications being shown as Application 1 (304), Application 2 (306), Application 3 (308), and so forth. The Menu Application 310 is shown as a horizontal layer that fits upon, or is built upon, the platform 302. This layer can be thought to extend across the entire platform 302 in order to handle menu structuring for any application running on the platform.

A representative Web Page 312 is shown which includes a window for running the application 314. A top menu area 316 is shown displaying the hierarchy of menu items (i.e., Menu Item 1, Menu Item 2, and so forth). The left column 318 shows a list of functionality that is associated with each of the chosen applications running in window 314. The Menu Application 310 is actually responsible for rendering certain portions (i.e., the menu portions) of the web page. The application is contained within the area 314. Clicking on different links within the application might bring up still another application, along with its associated menu structure. Note that the menus could be displayed in any of a variety of styles and formats as detailed above.

The Menu Application 310 interacts with a Menu Hierarchy file 320, which is an XML (Extensible Markup Language) file in the present embodiment (i.e., herein named Menu_Hierarchy.xml). This file contains a list of menu hierarchies that have been “registered” in the structure. When a new application is introduced, all the developer must do is register the application in the menu hierarchy structure, which is stored in this XML file. The Menu Application will then be able to use this file—in a runtime environment—to render the menus in relation to that running application.

The Menu Hierarchy file 320 might also include links to files that contain different display formats—in relation to Personalization, Globalization, or the like—as described in more detail below. A representative link 322 is shown, which might point to files including Image Resource 1 (324), Image Resource 2 (326), and so forth. A User 328 is further shown using a Front Graphical Editor 330 for creating and revising menu styles.

The present invention therefore provides a layer that separately handles all of the rendering associated with the menus. By separating the process of menu rendering to be outside of the development of applications, the developer does not have to worry about how to render the menu. The menu module instead has full control over how to configure the menu, and the different styles that will ultimately be used (i.e., top, middle, bottom, and so forth). For instance, in a “Catalog” application (used to display a range of products for a merchant), the user might want to invoke the additional functionality of browsing through the catalog or performing a search. These functions serve as entry points into the application and can be registered into the menu interface. The menu interface will then render these entry points as hyperlinks on the side (or other locations specified). The developer can proceed to build these different functions into an application but without worrying about how such functionality will be rendered. Instead, the functionality will show up—during runtime generation—in the displayed menus as appropriate links.

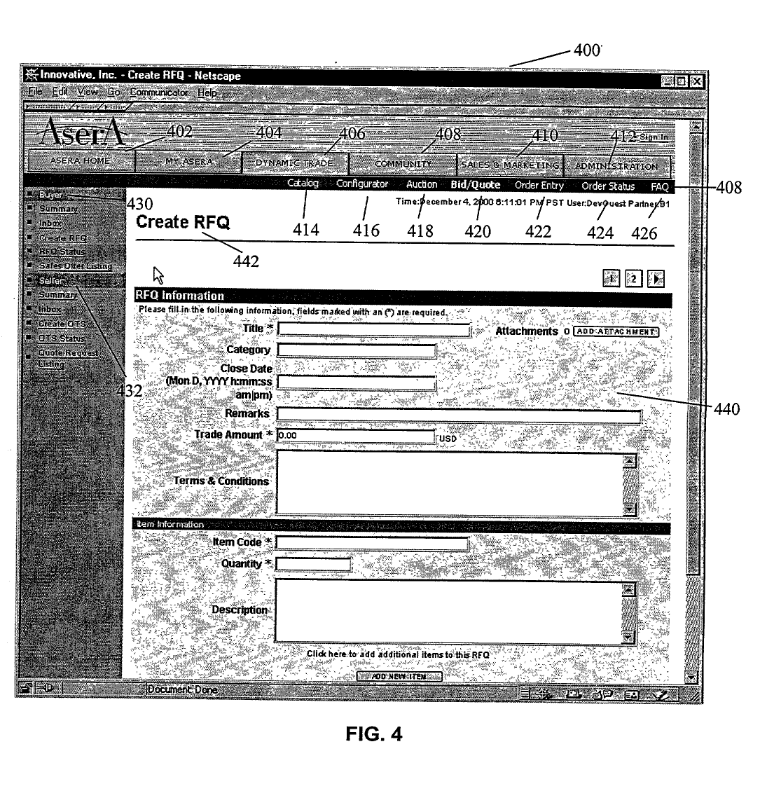

FIG. 4 next shows an example of a Web Page 400 from the Asera Platform. Various categorical tabs are shown, including Asera Home 402, My Asera 404, Dynamic Trade 406, Community 408, Sales & Marketing 410, and Administration 412. In this instance, the Dynamic Trade tab 406 has been selected (and is emphasized). The selection of this tab 406 brings up a menu display area 408, which includes the applications that are supported by Dynamic Trade. These include Catalog 414, Configurator 416, Auction 418, Bid/Quote 420, Order Entry 422, Order Status 424, and FAQ 426. In this instance, the application Bid/Quote 420 has been selected and is emphasized. The left hand column 430 thereafter shows the list of functionality associated with the Bid/Quote application. This functionality has buyer actions 430 including Summary, Inbox, Create RFQ, RFQ Status, and Sales Offer Listing. Seller actions 432 include Summary, Inbox, Create OTS, OTS Status, and Quote Request Listing. In the application window 440, the interactive screen for the functional selection “Create RFQ” 442 is shown. Fields for the RFQ information are provided for entry by the user.

From a functional standpoint, given that the user might need to view the “Catalog” and see a particular product involved, the menu structure provides a link that goes directly into the catalog application. Moreover, after the RFQ is executed and completed, it might go on to become an order. Accordingly, a link to the “Order Entry” application is provided. Any of these displayed applications can be quickly changed through the centralized navigation to the site as provided through the Menu Application and its interpretation of the configuration file.

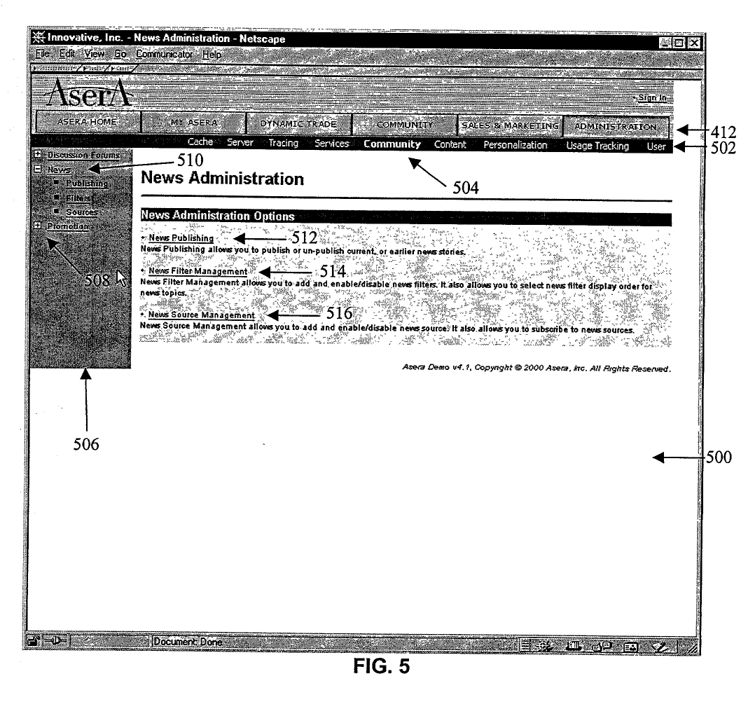

FIG. 5 next shows a representative Web Page for News Administration 500. The Administration tab 412 has been selected, and the associated applications are shown in menu display area 502. These representative applications include Cache, Server, Tracing, Service, Community, Content, Personalization, Usage Tracking, and User. In this instance, the Community application 504 has been selected and is emphasized. In the menu display area 506, the shown representative functionality includes Discussion Forums, News and Promotion. The “+” and “−” symbols (i.e., 508) indicate that these functionality listings can be expanded or contracted to show even more options. News 510 has been expanded to show the additional functional choices of Publishing, Filters, and Sources. The application window area 512 shows the News Administration screen, which also includes links to other options, including News Publishing 512, News Filter Management 514, and News Source Management 516.

For each representative Figure above, the menu hierarchy shows example applications associated with the tabs and subsequent functionality associated with the applications. With the present invention, all of these aspects are dynamic and can be readily changed. Whereas in the past, the application developer would need to make changes to the actual underlying code in order to render the display to include a new application, the present invention handles the display configuration with the Menu Application. When a new application is introduced, the developer simply registers the application with the menu hierarchy, which is stored in the XML configuration file. The Menu Application then uses the XML file to facilitate the automatic rendering of the new menu structure.

Site Map.

The present invention can also provide a broader viewpoint of the whole web site through reference to the configuration file. In the end, the whole menu hierarchy for the web site is registered in the XML configuration file. Individual site maps relating to the individual applications are generated therefrom, as needed. However, the “view” within any one application is generally limited to the functionality directly associated with the application. Moreover, applications generally are not “aware” of other applications available within the general community (or web site). As a result, the user is usually required to click around (or search) to find neighboring functionality.

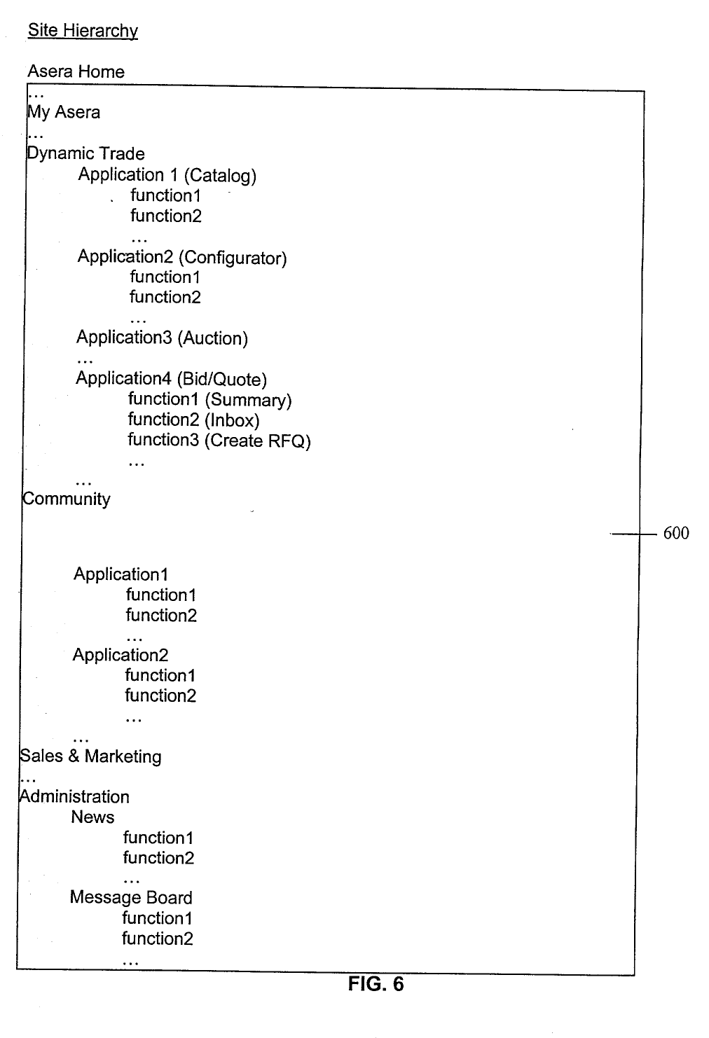

In contrast, FIG. 6 shows an example site hierarchy 600 pertaining to the above example web pages. By pulling up this site map (or portions thereof), the user can quickly see, and navigate through, the various other applications and functionality associated with the entire site.

In general, each item of functionality will correspond to a URL (or link). The menu module needs to know how to invoke these particular functions. Any associated application thereby needs to expose an interface, which indicates all the functions that are to be available in association with the application. These functions can thereafter be added into the menu hierarchy.

Configurability.

This structure also proves to be very flexible and configurable. For instance, one customer (or parent group) might have all functions exposed for them. Another user might only want a limited number of functions exposed (with more added later). Accordingly, the menu configuration file of the menu hierarchy can be changed to show only the functionality desired. This approach is equally applicable to applications (or functionality) built within a set environment (such as the platform shown), or to applications (or functionality) that are external to the set environment. For instance, a reference or link might be provided to a well known web portal or the like (i.e., Yahoo). This link is registered within the menu hierarchy, and then later rendered as a functional link to that external site.

Java classes might also be written into an application. Notably, there are some method calls wherein the Java classes expose an external interface. The menu module then serves as the caller that will interpret what the Java classes expose as an external interface and then make the call to that interface. In the configuration file, these interfaces will be registered and then become available as displayed functionality within the menu structures.

Access to Functionality.

Every application will have a number of functionalities. Those functionalities will be registered in the file Menu_Hierarchy.xml. When the menus are rendered, the user then has many choices. The user can, however, disable certain menu items. Hence, even though the functionality is registered and exists within the XML file, the functionality will still not show up on the user's display screen. This limited access to certain functionality might be dependent upon the identity of the user. For certain high-level users, perhaps more functionality will be made available than for lower-level users. Hence, the Menu Application serves to render the menu items intelligently, based upon access levels and such (i.e., identity of the user).

Other aspects besides the level of the user identity might be used to limit display of certain functionality. For instance, if a customer buys certain applications from Asera, the user might not wish to buy all of the applications. Rather than have to remove code or tailor each deliverable, the developer can instead go inside the file Menu_Hierarchy.xml and mark a certain entry for disablement. Once disabled, the particular application or functionality will not show up on the customer's resulting menu displays.

Related features might also include personalization by the user. For instance, a user might have access to a total of 20 applications, but might only want to regularly access only the five applications that are used the most. The user could then configure the access level to applications according to their own needs. This configurability would be available to end users and to administrators, depending upon the amount of control provided by the developer in relation to the application.

Appearance.

Another powerful feature relating to the present invention pertains to the restructuring of web sites. Often web sites are restructured so as to affect the whole look and feel of the site. For instance, based upon user feedback, the site provider might want to move all of the menus from one location to another (i.e., from the top, over to the side). By having the Menu Application layer handle everything related to the menus, then by simply changing the configuration file, the web site can support a completely different rendering style. Moreover, different styles can be quickly supported by providing different image map files (or the like) and altering the configuration file to recognize one set as opposed to the other.

The present approach also makes it easy to control the placement of the links on the menu structures. The configuration file exists generally as an XML tree of applications, and the functionality associated with the applications. If a series of links needs to appear under a menu item, they might be copied and moved from one menu item to another in the hierarchy file. Upon rendering the menus again, the XML file will be interpreted, and the menu links will be moved to the new location.

Globalization.

The Menu Application also supports principles behind globalization of the applications running on a platform. Menus might be developed and provided (via image files or the like) based upon different languages. Items within the file Menu Hierarchy file point to different image resources. In general, rather than pointing to a “gif” file (or the like), the present embodiment points to an image resource file. Based upon the identity of the user (or the locale of the user), a particular set of images will be selected (and/or created) to provide the preferred language for display in the menus. During runtime, any of a variety of criteria (e.g., identity, locale, etc.) can be used to pick out a version of menus (e.g., Japanese menus or English menus), and thereafter render them for display.

Personalization.

The user might also utilize the present system to conveniently personalize the displayed menu items. The identity of the user can be used to pull up personalized settings or menu structures that have been constructed by/for the user. One aspect of personalization would include co-branding of products or services. A version of the menu structures could be provided for each of a group of vendors. Thereafter, each vendor might further customize their menu display files to include co-branding with other vendors.

Menu Hierarchy File.

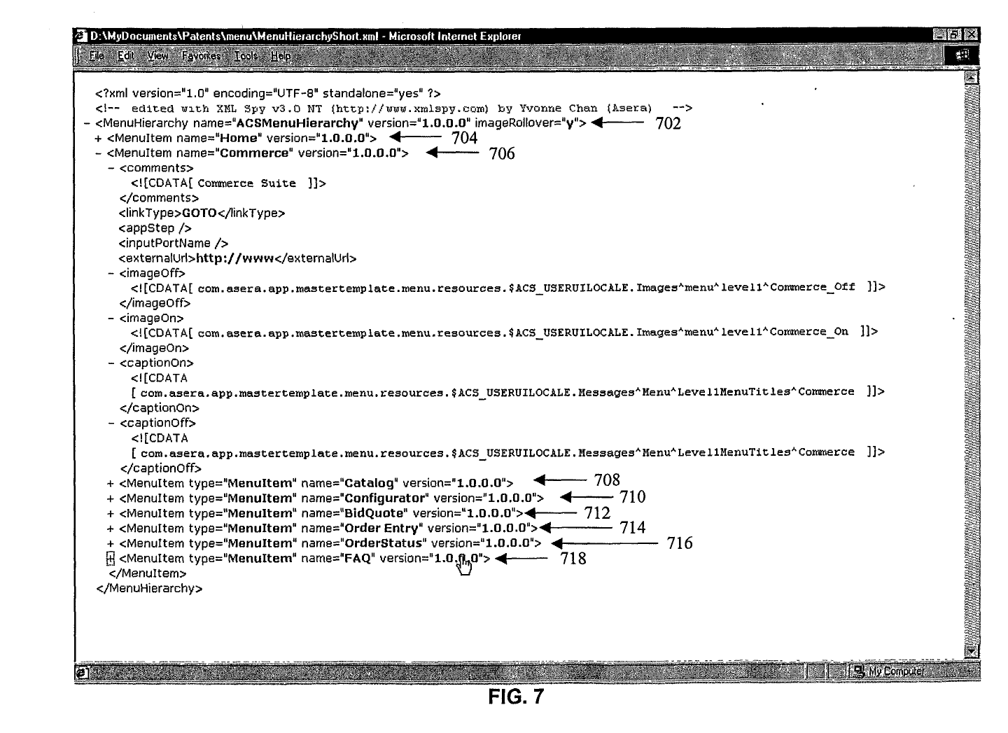

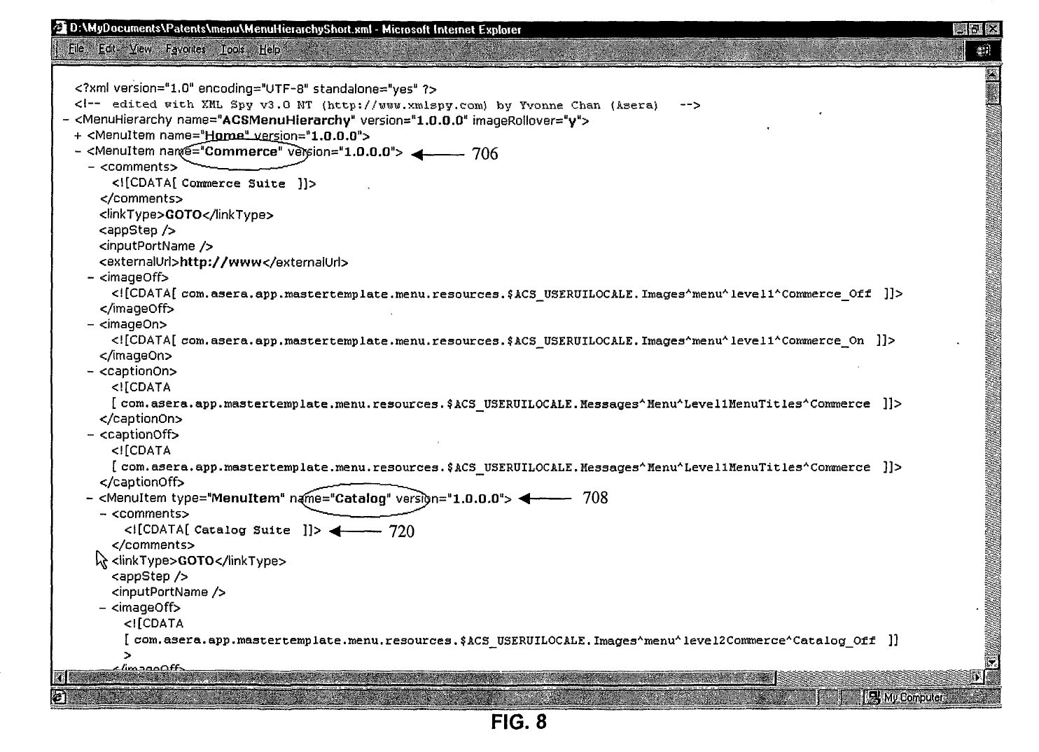

As described above, an example of the Menu Hierarchy file in XML format is provided in Appendix A. FIGS. 7 and 8 provide more detailed excerpts of the Menu Hierarchy file. FIG. 7 shows an example of the ACS Menu Hierarchy. The menu item “Home” is shown as 704, and the menu item “Commerce” is shown as 706. A list of applications is shown “registered” under the Commerce. This list includes Catalog 708, Configurator 710, BidQuote 712, Order Entry 714, OrderStatus 716, and FAQ 718. The “+” signs at the left of each menu item type and name indicate that the entry can be further expanded. FIG. 8 shows an example of this where Catalog 708 has been expanded, and further information pertaining to the Catalog Suite 720 is shown. To move items from one area of the menu to another, menu hierarchy lines, for instance, the list of application names would simply need to be copied and pasted to another area in order to be rendered under a different menu item.

The Menu Hierarchy file does not necessarily need to be an XML file. It might be any other type of file that provides a structural map of the menu structure for a web site or platform. In the present instance, an XML file is used as preferred by the example Asera system. The Menu Hierarchy file is stored on the Asera system

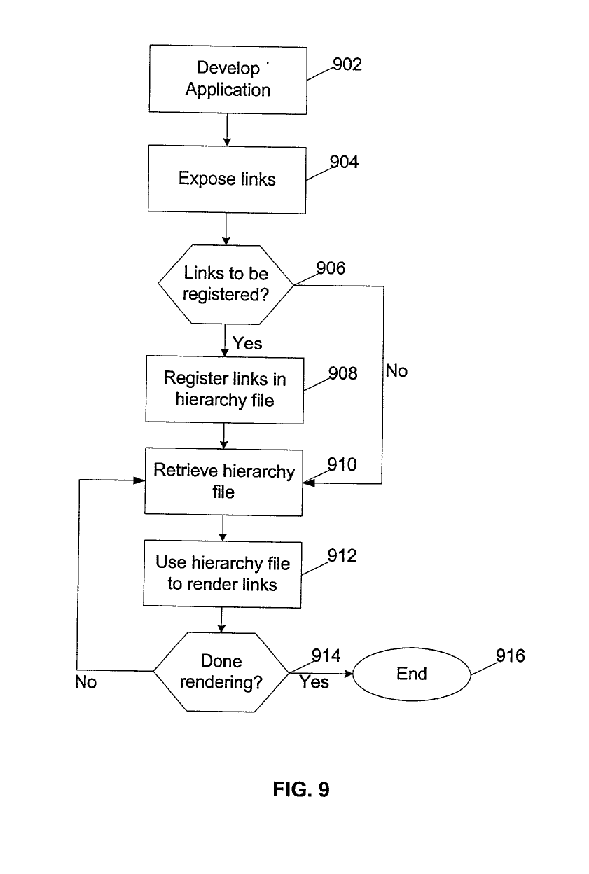

FIG. 9 next shows a flowchart 900 of certain representative steps that might be used in association with the present invention. In step 902, the application is developed by a developer (or user) via the underlying platform (i.e., Asera development platform, or the like). In step 904, the links are exposed within the application. These links might include internal links within the application and/or platform, or external links. The links might include URLs or the like within the display area of the rendered application or links to menu items (functionalities) within menu display areas. Decision block 906 next inquires whether there are links to be registered. If yes, then the links are registered within the hierarchy file as shown in step 908. If no, then the hierarchy file is retrieved in step 910. In step 912, the hierarchy file is utilized to render the links. Decision block 914 inquires whether the rendering is complete. If no, then the hierarchy file is retrieved in step 910 and the rendering continues. If yes, then the process ends.

While the invention has been illustrated and described in detail in the drawings and foregoing description, such illustrations and descriptions are to be considered as exemplary and not restrictive in character, it being understood that only certain embodiment(s) and minor variants thereof have been shown and described, and that all changes and modifications that come within the spirit of the invention are desired to be protected.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A menu generating apparatus for rendering and displaying menu items associated with applications running on a computing platform, the menu generating apparatus comprising:
a platform for running a plurality of applications;
a menu application associated with the plurality of applications running on the platform; and
a menu hierarchy file that is accessible by the menu application, wherein menu items pertaining to the plurality of applications are registered and stored in the menu hierarchy file, whereby the menu application layer utilizes the stored menu hierarchy for rendering the menu selections.

2. The menu generating apparatus of claim 1, wherein the menu application is built upon the platform as a horizontal layer associated with any of the plurality of applications.

3. The menu generating apparatus of claim 1, wherein the menu application renders the menu items separate from the process used to render the application.

4. The menu generating apparatus of claim 1, wherein the menu hierarchy file is an XML file.

5. The menu generating apparatus of claim 4, wherein the menu hierarchy file has an associated document type definition (DTD) for use with an SGML compiler.

6. The menu generating apparatus of claim 1, wherein the computing platform is a web-based serving platform for running the applications.

7. The menu generating apparatus of claim 6, wherein the web-based serving platform facilitates development of business applications for users of a web site that is associated with the web-based serving platform.

8. The menu generating apparatus of claim 6, wherein the menu hierarchy file is retrieved and used to provide a hierarchical view of the web site to the user.

9. The menu generating apparatus of claim 1, wherein graphical image files are stored with display information for menu structures.

10. The menu generating apparatus of claim 9, wherein certain graphical image files are selected based upon user identity.

11. The menu generation apparatus of claim 9, wherein certain graphical image files are selected based upon user locale.

12. A method for rendering and displaying menu items associated with applications running on a computing platform, the method comprising the steps of:
developing an application having links to be displayed in association with the application;
exposing the links within the application;
registering the links in a menu hierarchy file that is stored in association with the computing platform; and
retrieving the menu hierarchy file from the storage area; and
using the menu hierarchy file to render the links in designated areas of a display.

13. The method according to claim 12, wherein the links include menu items.

14. The method according to claim 13, wherein the designated areas of display include menu display areas.

15. The method according to claim 13, wherein a further step includes designating certain graphical image files to be used in forming aspects of the menu display.

16. The method of claim 15, wherein a further step includes selecting certain graphical image files based upon the identity of the user.

17. The method of claim 15, wherein a further step includes selecting certain graphical image files based upon the locale of the user.
